(19) United States
(12) Patent Application Publication
(10) Pub. No.: US 2010/0151340 A1
(43) Pub. Date: Jun. 17, 2010

(54) FUEL CELL IN-PLANE STATE ESTIMATING SYSTEM AND FUEL CELL IN-PLANE STATE ESTIMATING METHOD

(76) Inventor: Kotaro Ikeda, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/600,496

(22) PCT Filed: May 23, 2008
(86) PCT No.: PCT/IB2008/001291

§ 371 Date: Nov. 17, 2009

(30) Foreign Application Priority Data
May 24, 2007 (JP) 2007-138333

(51) Int. Cl. H01M 8/04

(52) U.S. Cl. 429/431

(57) ABSTRACT

The membrane electrode assembly is virtually divided into a plurality of small regions arranged along the flow of reactive gases. A current density 132 and a transfer amount 136 of water in an n−1 region are calculated referring to the maps defining a relationship between a power generation environment and a current density and a relationship between the power generation environment and a transfer amount of water, on the basis of power generation environments 122 and 128 transmitted from a pre-stage. Consumption amounts 138 and 146 of the reactive gases are calculated from the current density 132. A power generation environment transmitted to an n region is calculated by reflecting the consumption amounts 138 and 146 of the reactive gases and the transfer amount 136 of water (140, 144, 148, 150). Power generation environments and power generation states are sequentially predicted as to all the small regions.

### BACKGROUND OF THE INVENTION

1. Field of the Invention

The invention relates to a fuel cell in-plane state estimating system and a fuel cell in-plane state estimating method, and more particularly, to an in-plane state estimating system and an in-plane state estimating method for accurately estimating a current distribution in a plane of each of membrane electrode assemblies constituting a fuel cell.

2. Description of the Related Art

Japanese Patent Application Publication No. 2005-347016 (JP-A-2005-347016) discloses a method for easily predicting an in-plane state of each of membrane electrode assemblies of a fuel cell. More specifically, the above-mentioned publication discloses a method in which a model of a membrane electrode assembly as an object to be predicted which is scaled down to 1/n is created and used to predict an in-plane state of the membrane electrode assembly.

In the aforementioned method of prediction, the in-plane state of the membrane electrode assembly is predicted according to an existing calculation method. The calculation method used in this case needs to be developed through an enormous amount of adaptation operations and the like. It takes therefore a long time to develop the calculation method. If a 1/n scale model is used to perform predictive calculation, the time for developing the calculation method can be significantly reduced in comparison with a case where a full-size membrane electrode assembly is used for prediction. In this respect, the aforementioned method of prediction is effective as a method for easily predicting an in-plane state of a membrane electrode assembly.

However, a phenomenon occurring in the 1/n scale model does not exactly coincide with a phenomenon occurring in the full-size membrane electrode assembly. In the aforementioned method of prediction, therefore, it is difficult to accurately predict an in-plane state produced in a real membrane electrode assembly. Even if the 1/n scale model is used, it still takes a lot of time according to the aforementioned method to develop a calculation method corresponding to the model. In this respect, the aforementioned method leaves room for improvement in terms of both the man-hour for development and the accuracy in making prediction.

### SUMMARY OF THE INVENTION

The invention provides an in-plane state estimating system and an in-plane state predicting method that make it possible to easily and accurately predict a distribution of power generation amount in a plane of each of membrane electrode assemblies of a fuel cell.

A first aspect of the invention relates to a fuel cell in-plane state estimating system. This fuel cell in-plane state estimating system is equipped with a membrane electrode assembly of a fuel cell having an anode and a cathode to which reactive gases are supplied respectively to generate power, power generation characteristic storing means for storing a power generation characteristic defining a relationship between a power generation amount and a power generation environment of the membrane electrode assembly, consumption production characteristic storing means for storing a consumption production characteristic defining a relationship between consumption amounts of the reactive gases in the membrane electrode assembly and the power generation amount and a relationship between a production amount of water and the power generation amount, inlet environment deciding means for deciding power generation environments at inlets of the reactive gases, small region defining means for virtually dividing the membrane electrode assembly into a plurality of small regions arranged along the flow of the reactive gases, power generation amount calculating means for calculating a power generation amount in a first small region as one of the plurality of the small regions on the basis of a power generation environment of a second small region located upstream of the first small region with respect to the flow of the reactive gases according to the power generation characteristic, consumption production amount calculating means for calculating consumption amounts of the reactive gases and a production amount of water in the first small region on the basis of the power generation amount of the first small region according to the consumption production characteristic, and power generation environment updating means for reflecting consumption amounts of the reactive gases and a production amount of water in the second small region on the power generation environment of the second small region to calculate a power generation environment of the first small region.

The fuel cell in-plane state estimating system may further be equipped with resistance characteristic storing means for storing a resistance characteristic defining a relationship between a resistance value and a power generation environment of the membrane electrode assembly, and resistance value calculating means for calculating a resistance value in the first small region on the basis of the power generation environment of the second small region according to the resistance characteristic.

The fuel cell in-plane state estimating system may be equipped with water transfer characteristic storing means for storing a water transfer characteristic defining a relationship between a transfer amount of water from the cathode of the membrane electrode assembly to the anode of the membrane electrode assembly and a power generation environment of the membrane electrode assembly, and water transfer amount calculating means for calculating a transfer amount of water in the first small region on the basis of the power generation environment of the second small region according to the water transfer characteristic. The power generation environment may include an amount of water present in the cathode of the membrane electrode assembly and an amount of water present in the anode of the membrane electrode assembly. The power generation environment updating means may include cathode water amount updating means for subtracting a transfer amount of water in the second small region from a sum of an amount of water present in the cathode in the second small region and a production amount of water in the second small region to calculate an amount of water present in the cathode in the first small region, and anode water amount updating means for adding the transfer amount of water in the second small region to an amount of water present in the anode in the second small region to calculate an amount of water present in the anode in the first small region.

The reactive gas supplied to the cathode may be oxidizing gas containing oxygen. The reactive gas supplied to the anode may be fuel gas containing hydrogen. The consumption production amount calculating means may include oxygen consumption amount calculating means for calculating a consumption amount of oxygen generated by the cathode of each of the plurality of the small regions, and hydrogen consumption amount calculating means for calculating a consumption amount of hydrogen generated by the anode in each of the plurality of the small regions. The power generation environment may include an amount of oxygen present in the cathode of the membrane electrode assembly, and an amount of hydrogen present in the anode of the membrane electrode assembly. The power generation updating means may include oxygen amount updating means for subtracting a consumption amount of oxygen in the second small region from an amount of oxygen present in the cathode in the second small region to calculate an amount of oxygen present in the cathode in the first small region, and hydrogen amount updating means for subtracting a consumption amount of hydrogen in the second small region from an amount of hydrogen present in the anode in the second small region to calculate an amount of hydrogen present in the anode in the first small region.

The membrane electrode assembly may be equipped with a coflow flow channel through which the reactive gas supplied to the cathode and the reactive gas supplied to the anode flow in the same direction. That one of the small regions which is located upstream of each of the small regions with respect to the flow of the reactive gases may be common to both the cathode and the anode.

The membrane electrode assembly may be equipped with a counter flow channel through which the reactive gas supplied to the cathode and the reactive gas supplied to the anode flow in opposite directions. That one of the small regions which is adjacently located upstream of each of the small regions with respect to the flow of the reactive gas supplied to the cathode may be the second small region on the cathode side. That one of the small regions which is adjacently located upstream of each of the small regions with respect to the flow of the reactive gas supplied to the anode may be the second small region on the anode side.

A second aspect of the invention relates to a fuel cell in-plane state estimating method. This fuel cell in-plane state estimating method includes a step of supplying reactive gases to an anode and a cathode of a membrane electrode assembly of a fuel cell respectively, a step of deciding power generation environments at inlets of the reactive gases, a step of virtually dividing the membrane electrode assembly into a plurality of small regions arranged along the flow of the reactive gases, a step of calculating a power generation amount in a first small region as one of the plurality of the small regions on the basis of a power generation environment of a second small region located upstream of the first small region with respect to the flow of the reactive gases according to a power generation characteristic defining a relationship between a power generation amount and a power generation environment of the membrane electrode assembly, a step of calculating consumption amounts of the reactive gases and a production amount of water in the first small region on the basis of the power generation amount in the first small region according to a consumption production characteristic defining a relationship between consumption amounts of the reactive gases in the membrane electrode assembly and the power generation amount and a relationship between a production amount of water in the membrane electrode assembly and the power generation amount, and a step of reflecting consumption amounts of the reactive gases and a production amount of water in the second small region on the power generation environment of the second small region to calculate a power generation environment of the first small region.

The fuel cell in-plane state estimating method may further include a step of preparing a membrane electrode assembly piece having the same structure as the membrane electrode assembly and having such a size as can make an in-plane power generation environment substantially homogeneous, a step of supplying reactive gases to an anode and a cathode of the membrane electrode assembly piece respectively, a step of measuring a power generation amount of the membrane electrode assembly piece while changing power generation environments at inlets of the reactive gases, and a step of producing the power generation characteristic on the basis of a result of the step of measuring the power generation amount of the membrane electrode assembly piece.

The fuel cell in-plane state estimating method may further include a step of calculating a resistance value in the first small region on the basis of the power generation environment of the second small region according to a resistance characteristic defining a relationship between a resistance value and a power generation environment of the membrane electrode assembly.

The fuel cell in-plane state estimating method may further include a step of preparing a membrane electrode assembly piece having the same structure as the membrane electrode assembly and having such a size as can make an in-plane power generation environment substantially homogeneous, a step of supplying reactive gases to an anode and a cathode of the membrane electrode assembly piece respectively, a step of measuring a resistance value of the membrane electrode assembly piece while changing power generation environments at inlets of the reactive gases, and a step of producing the resistance characteristic on the basis of a result of the step of measuring the resistance value of the membrane electrode assembly piece.

The fuel cell in-plane state estimating method may include a step of calculating a transfer amount of water in the first small region on the basis of the power generation environment of the second small region according to a water transfer characteristic defining a relationship between a transfer amount of water from the cathode of the membrane electrode assembly to the anode of the membrane electrode assembly and a power generation environment of the membrane electrode assembly, a step of subtracting a transfer amount of water in the second small region from a sum of an amount of water present in the cathode in the second small region and a production amount of water in the second small region to calculate an amount of water present in the cathode in the first small region when the power generation environment includes an amount of water present in the cathode of the membrane electrode assembly and an amount of water present in the anode of the membrane electrode assembly, and a step of adding the transfer amount of water in the second small region to an amount of water present in the anode in the second small region to calculate an amount of water present in the anode in the first small region.

The fuel cell in-plane state estimating method may include a step of preparing a membrane electrode assembly piece having the same structure as the membrane electrode assembly and having such a size as can make an in-plane power generation environment substantially homogeneous, a step of supplying reactive gases to an anode and a cathode of the membrane electrode assembly piece respectively, a step of measuring a transfer amount of water in the membrane electrode assembly piece while changing power generation environments at inlets of the reactive gases, and a step of producing the water transfer characteristic on the basis of a result of the step of measuring the transfer amount of water in the membrane electrode assembly piece.

According to the first aspect of the invention, power generation amounts in the virtually divided respective small regions can be accurately obtained through calculation sequentially from those small regions at a pre-stage to those small regions at a post-stage. That is, the power generation environment at each of the inlets of the reactive gases is the power generation environment of that one of the small regions which is located on the most upstream side with respect to the flow of a corresponding one of the reactive gases. Thus, the power generation amount of that one of the small regions which is located on the most upstream side with respect to the flow of the reactive gases can be calculated on the basis of the power generation characteristic. When the power generation amount is known, the consumption amounts of the reactive gases and the production amount of water in that one of the small regions can be calculated on the basis of the consumption production characteristic. When the consumption amounts of the reactive gases and the production amount of water are known, the power generation environment transmitted by that one of the small regions to those small regions at the post-stage can be predicted. Using this power generation environment, power generation amounts in those small regions at the post-stage can be predicted. Power generation amounts of the plurality of the respective small regions can be accurately and easily calculated through the repetition of the foregoing processing.

By using the resistance characteristic defining the relationship between the resistance value and the power generation environment, the distribution of resistance value in the plane of the membrane electrode assembly can also be predicted.

By using the water transfer characteristic defining the relationship between the transfer amount of water and the power generation environment, the transfer amount of water in each of the small regions can be accurately predicted. When the transfer amount of water can be predicted, the amount of water present in the cathode in each of the small regions and the amount of water present in the anode in each of the small regions can be accurately predicted. Thus, the amount of water as one factor of the power generation environment can be accurately updated sequentially for the respective small regions.

The amount of hydrogen present in the anode in each of the small regions and the amount of oxygen present in the cathode in each of the small regions can be accurately predicted. The amount of hydrogen in the anode and the amount of oxygen in the cathode are each one factor of the power generation environment having an influence on the power generation amount of the membrane electrode assembly. That is, the amounts of hydrogen in the anode as one factor of the power generation environment and the amounts of oxygen in the cathode as one factor of the power generation environment can be accurately updated sequentially for the respective small regions.

The distribution of current in the plane can be predicted for the membrane electrode assembly equipped with the coflow flow channel.

The distribution of current in the plane can be predicted for the membrane electrode assembly equipped with the counter flow channel.

By using the power generation characteristic defining the relationship between the power generation amount and the power generation environment, the distribution of power generation amount in the plane of the membrane electrode assembly can be accurately predicted.

According to the second aspect of the invention, the power generation characteristic can be easily produced by using the membrane electrode assembly piece. That is, the in-plane power generation environment can be made substantially homogeneous in the membrane electrode assembly piece. Thus, when the amount of the current generated by the membrane electrode assembly piece is measured while changing the power generation environments at the inlets of the reactive gases, the power generation characteristic can be easily produced.

By using the resistance characteristic, the distribution of resistance value in the plane of the membrane electrode assembly can be accurately predicted.

By measuring the resistance value of the membrane electrode assembly piece while changing the power generation environments at the inlets of the reactive gases, the resistance characteristic can be easily produced.

By using the water transfer characteristic, the transfer amount of water in each of the small regions of the membrane electrode assembly can be accurately predicted. By taking the transfer amount of water in each of the small regions into account, the amount of water present in the anode in each of the small regions and the amount of water present in the cathode in each of the small regions can be accurately predicted.

By measuring the transfer amount of water in the membrane electrode assembly piece while changing the power generation environments at the inlets of the reactive gases, the resistance characteristic can be easily predicted.

### BRIEF DESCRIPTION OF THE DRAWINGS

The foregoing and further objects, features and advantages of the invention will become apparent from the following description of embodiments with reference to the accompanying drawings, wherein like numerals are used to represent like elements and wherein:

FIG. 1 is a diagram for explaining the configuration of a system according to the first embodiment of the invention;

FIGS. 2A and 2B each show a map of a current density I that is used by the system according to the first embodiment of the invention;

FIGS. 3A and 3B each show a map of a resistance value R that is used by the system according to the first embodiment of the invention;

FIGS. 4A and 4B each show a map of a water transfer amount H₂O_m that is used by the system according to the first embodiment of the invention;

FIG. 5 is a diagram of a system for measuring a power generation state under a specific power generation environment using a membrane electrode assembly piece;

FIGS. 6A and 6B are views for explaining a method of virtually dividing a membrane electrode assembly with which a fuel cell shown in FIG. 1 is equipped;

FIG. 7 is a diagram for explaining a procedure in which the system according to the first embodiment of the invention predicts a power generation environment of an n region on the basis of a power generation environment of an n−1 region;

FIG. 8 is a flowchart of a routine executed in the system according to the first embodiment of the invention;

FIG. 9 is a diagram for explaining the contents of processings performed on a cathode side in the second embodiment of the invention;

FIG. 10 is a diagram for explaining the contents of processings performed on an anode side in the second embodiment of the invention;

FIG. 11 is a flowchart of a routine executed in a system according to the second embodiment of the invention; and

FIG. 12 is a diagram showing a result of the prediction of distribution made by the system according to the second embodiment of the invention.

### DETAILED DESCRIPTION OF THE EMBODIMENTS

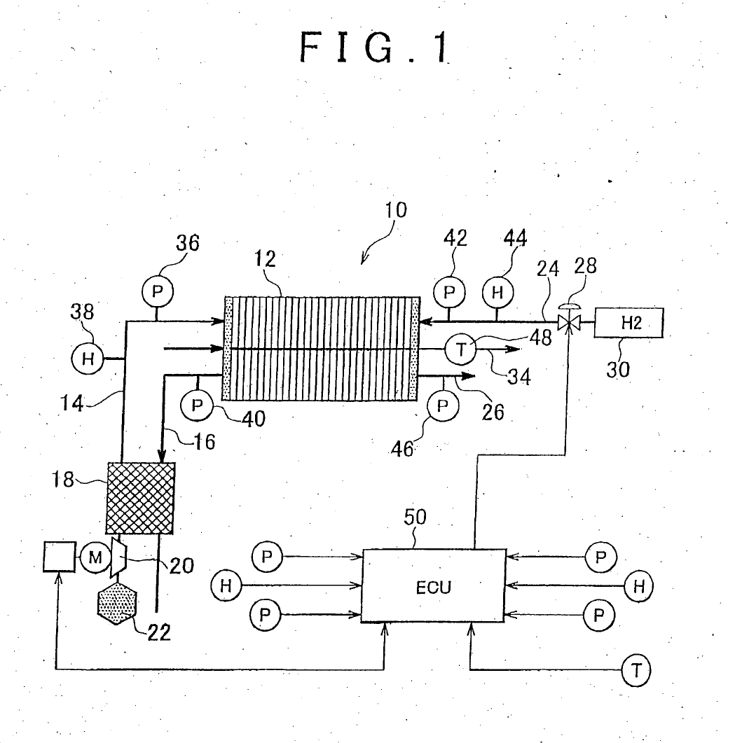

FIG. 1 is a diagram for explaining the configuration of a system according to the first embodiment of the invention. The system shown in FIG. 1 is equipped with a fuel cell 10. The fuel cell 10 is equipped with a plurality of laminated membrane electrode assemblies 12. The membrane electrode assemblies 12 constitute a plate-like structure extending in the depth direction with respect to the sheet of FIG. 1.

An anode and a cathode are formed across an electrolyte membrane inside each of the membrane electrode assemblies 12. A gas flow channel for causing fuel gas containing hydrogen (hydrogen gas in this embodiment of the invention) to flow through the inside of a plane is formed on the anode side. A gas flow channel for causing oxidizing gas containing oxygen (air in this embodiment of the invention) to flow through the inside of a plane is formed on the cathode side. In addition, a coolant passage for causing coolant to flow therethrough is formed on a border between any adjacent ones of the membrane electrode assemblies. The constructions of the fuel cell 10 and the membrane electrode assemblies 12 are known and therefore will not be described below any further.

An oxidizing gas supply passage 14 and an oxidizing gas discharge passage 16 communicate with the fuel cell 10. The oxidizing gas supply passage 14 communicates with a compressor 20 via a humidifier 18. The compressor 20 can supply air sucked through an air filter 22 to the fuel cell 10 via the oxidizing gas supply passage 14.

The air supplied from the oxidizing gas supply passage 14 to the fuel cell 10 is distributed to cathode-side gas flow channels with which the plurality of the laminated membrane electrode assemblies 12 are equipped respectively. The air thus distributed flows through the insides of cathode-side planes of the respective membrane electrode assemblies and then is discharged from the oxidizing gas discharge passage 16.

In causing oxygen and hydrogen to react with each other to generate power, the fuel cell 10 produces water on the cathode side. Thus, the gas discharged from the oxidizing gas discharge passage 16 contains water. The humidifier 18 has a function of humidifying the air on the oxidizing gas supply passage 14 side using the water contained in the oxidizing gas discharge passage 16. Thus, according to the system shown in FIG. 1, the humidified air can be supplied to the cathode side of the fuel cell 10.

A fuel gas supply passage 24 and a fuel gas discharge passage 26 communicate with the fuel cell 10. A hydrogen tank 30 communicates with the fuel gas supply passage 24 via an adjusting valve 28. According to this configuration, hydrogen gas can be supplied at a desired pressure to the fuel cell 10 by adjusting the opening degree of the adjusting valve 28.

The hydrogen gas supplied to the fuel cell 10 is distributed to anode-side gas flow channels with which the plurality of the laminated membrane electrode assemblies 12 are equipped respectively. The hydrogen gas supplied to the anode side flows through the insides of planes of the respective membrane electrode assemblies and then is discharged from the fuel gas discharge passage 26.

In this embodiment of the invention, each of the membrane electrode assemblies 12 has a coflow flow channel. That is, the cathode-side gas flow channel and the anode-side gas flow channel of each of the membrane electrode assemblies 12 are provided such that reactive gases flow therethrough respectively in the same direction. More specifically, each of the membrane electrode assemblies 12 according to this embodiment of the invention is constructed such that both fuel gas on the anode side and oxidizing gas on the cathode side flow, in a state shown in FIG. 1, downward with respect to the sheet thereof.

Furthermore, a coolant supply passage 32 and a coolant discharge passage 34 communicate with the fuel cell 10. The coolant that has flowed in from the coolant supply passage 32 flows through respective borders between adjacent ones of the membrane electrode assemblies 12 and then is discharged from the coolant discharge passage 34. Owing to this coolant, the temperature of the fuel cell 10 is controlled to, for example, about 80° C.

In the system according to this embodiment of the invention, as shown in FIG. 1, the oxidizing gas supply passage 14 is equipped with a pressure gauge 36 and a dew point meter 38. A pressure gauge 40 is disposed in the oxidizing gas discharge passage 16.

The pressure gauge 36 and the dew point meter 38 can detect the pressure and humidity at a cathode-side inlet of each of the membrane electrode assemblies 12. The pressure gauge 40 can detect the pressure at a cathode-side outlet of each of the membrane electrode assemblies 12.

The system according to this embodiment of the invention is further equipped with a pressure gauge 42 and a dew point meter 44 disposed in the fuel gas supply passage 24, a pressure gauge 46 disposed in the fuel gas discharge passage 26, and a temperature gauge 48 disposed in the coolant discharge passage 34. These measuring instruments can detect the pressure and humidity at an anode-side inlet of each of the membrane electrode assemblies 12, the pressure at an anode-side outlet of each of the membrane electrode assemblies 12, and the temperature of each of the membrane electrode assemblies 12.

Outputs of the pressure gauges 36, 40, 42, and 46, the dew point meters 38 and 44, and the temperature gauge 48 are supplied to an electronic control unit (ECU) 50. Owing to the outputs of those measuring instruments, the ECU 50 can detect an environment regarding the pressure and temperature of each of the membrane electrode assemblies 12.

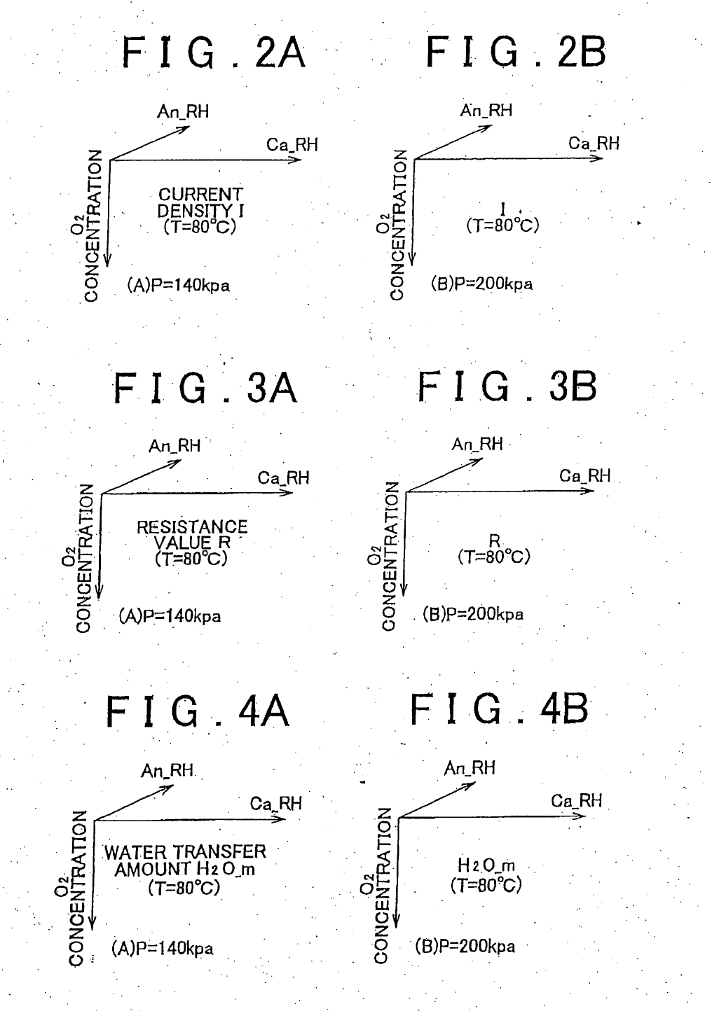

The system according to this embodiment of the invention accurately predicts the distribution of power generation in each of the membrane electrode assemblies 12 with which the fuel cell 10 is equipped. In order to realize this function, the ECU 50 has stored therein a plurality of maps shown in FIGS. 2 to 4. The ECU 50 has a central processing unit (CPU) (not shown), a random access memory (RAM) (not shown), a read only memory (ROM) (not shown), and an input/output interface. The ECU 50 has the plurality of the maps stored in a storage portion composed of the ROM, the RAM, and the like.

FIGS. 2 A and 2B show maps of a current density I. Each of the membrane electrode assemblies 12 generates power in the plane thereof at the current density I that corresponds to a power generation environment. FIGS. 2 A and 2B show maps each defining a relationship between a power generation environment surrounding each of the membrane electrode assemblies 12 and the current density I generated by each of the membrane electrode assemblies 12.

A power generation state of each of the membrane electrode assemblies 12 is decided by a plurality of parameters that will be described below. These parameters are generically referred to as a “power generation environment”. Among these parameters, the first parameter is a relative humidity An_RH of fuel gas flowing through the anode, and the second parameter is a relative humidity Ca_RH of oxidizing gas flowing through the cathode. The third parameter is a pressure P_An of the anode, the fourth parameter is a pressure P_Ca of the cathode, and the fifth parameter is a concentration of hydrogen in fuel gas flowing through the anode. The sixth parameter is a concentration of oxygen in oxidizing gas flowing through the cathode, and the seventh parameter is a temperature of each of the membrane electrode assemblies 12 (NB, “relative humidity”=(vapor pressure)/(saturated vapor pressure)×100).

Among the aforementioned seven parameters, the pressure P_An of the anode as the third parameter and the pressure P_Ca of the cathode as the fourth parameter are approximately equal to each other. In addition, the pressure P_An of the anode has a sufficiently smaller influence on the power generation state than the pressure P_Ca of the cathode. In this embodiment of the invention, therefore, the influence of the anode pressure P_An as the third parameter is ignored. Among the aforementioned parameters, the concentration of hydrogen as the fifth parameter is almost 100% regardless of position, and the temperature as the seventh parameter is approximately equal to the temperature of coolant regardless of position. In this embodiment of the invention, therefore, the concentration of hydrogen as the fifth parameter and the temperature as the seventh parameter are both handled as constant values.

FIGS. 2 A and 2B define relationships between the power generation environment decided by the remaining four parameters and the current density I. More specifically, FIG. 2A is a map defining the current density I generated in the case where the cathode pressure P_Ca is 140 Kpa in relation to the anode relative humidity An_RH, the cathode relative humidity Ca_RH, and the concentration of oxygen. FIG. 2B is a map defining the current density I generated in the case where the cathode pressure P_Ca is 200 Kpa in relation to the anode relative humidity An_RH, the cathode relative humidity Ca_RH, and the concentration of oxygen.

FIGS. 3A and 3B shows maps defining relationships between a resistance value R and a power generation environment of each of the membrane electrode assemblies 12 according to the same rule as in the cases of FIGS. 2 A and 2B. FIGS. 4A and 4B show maps defining relationships between a transfer amount H₂O_m of water from the cathode of each of the membrane electrode assemblies 12 to the anode thereof and a power generation environment of each of the membrane electrode assemblies 12 according to the same rule. When the power generation environment of each of the membrane electrode assemblies 12 is specified, the ECU 50 can predict the current density I, the resistance value R, and the water transfer amount H₂O_m that are generated under the power generation environment, by referring to those maps.

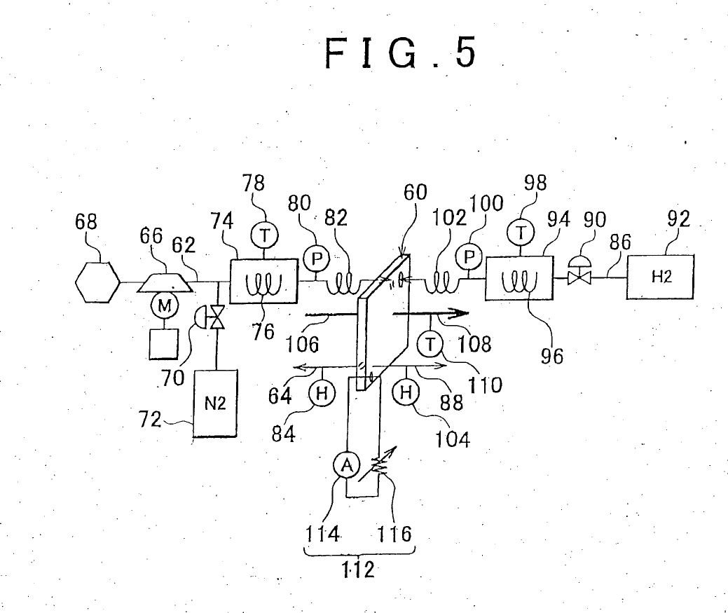

Next, a method of creating the maps shown in FIGS. 2 to 4 will be described with reference to FIG. 5. Each of the membrane electrode assemblies 12 shown in FIG. 1 has a sufficiently long distance between a location into which oxidizing gas flows and a location from which oxidizing gas flows out. The same holds true for a route into which fuel gas flows. Thus, the pressure of oxidizing gas and the pressure of fuel gas are not constant in the plane of each of the membrane electrode assemblies 12.

Each of the membrane electrode assemblies 12 produces water on the cathode side as power is generated. The produced water is caused to flow downstream as oxidizing gas flows. Thus, the amount of water on the cathode side is not homogeneous in the plane of each of the membrane electrode assemblies 12. As a result, the relative humidity Ca_RH on the cathode side is distributed along the flow of gas.

Water transfers to the anode side of each of the membrane electrode assemblies 12 from the cathode side thereof. The water that has thus transferred is caused to flow downstream due to the flow of fuel gas. Thus, the amount of water is not homogeneous either in the plane on the anode side. As a result, the relative humidity An_RH on the anode side is also distributed along the flow of gas.

Furthermore, each of the membrane electrode assemblies 12 consumes oxygen in the air supplied to the cathode to generate power. On the other hand, the concentration of oxygen in the plane of the cathode increases with decreases in the distance from the inlet of air (the inlet into which oxidizing gas flows), and decreases with decreases in the distance from the outlet of air (the outlet from which oxidizing gas flows out). In this manner, the concentration of oxygen on the cathode side is also distributed in the plane of each of the membrane electrode assemblies 12.

In creating the maps shown in FIGS. 2 to 4, it is necessary to specify a power generation environment and measure values resulting therefrom. Among the factors of the power generation environment to be specified in creating these maps, a temperature T and the pressure P_Ca can be relatively easily homogenized in the entire plane of each of the membrane electrode assemblies 12. However, it is difficult to homogenize the anode relative humidity An_RH, the cathode relative humidity Ca_RH, and the concentration of oxygen in the entire plane of each of the membrane electrode assemblies 12 as described above. It is therefore difficult to specify the power generation environment when each of the membrane electrode assemblies 12 is used in full size. Thus, in this embodiment of the invention, a membrane electrode assembly piece that is identical in structure but not in size to the membrane electrode assemblies 12 is created, and the aforementioned maps are created using this piece.

FIG. 5 is a diagram of a system for measuring a power generation state under a specific power generation environment using a membrane electrode assembly piece 60. The membrane electrode assembly piece 60 is equipped, on both sides of an electrolyte membrane, with a cathode-side gas flow channel and an anode-side gas flow channel as a coflow flow channel. The membrane electrode assembly piece 60 has such a size that the power generation environment from inlets of the gas flow channels to outlets of the gas flow channels, more specifically, the anode relative humidity An_RH, the cathode relative humidity Ca_RH, the concentration of oxygen, and the pressure can be regarded as homogeneous. In this case, the size of the membrane electrode assembly piece 60 is set as 1 cm×1 cm from the foregoing standpoint.

The system shown in FIG. 5 is equipped with an oxidizing gas supply passage 62 and an oxidizing gas discharge passage 64 that communicate with the cathode side of the membrane electrode assembly piece 60. A compressor 66 communicates with the oxidizing gas supply passage 62. The compressor 66 can supply air sucked via an air filter 68 toward the membrane electrode assembly piece 60.

A nitrogen tank 72 communicates with the oxidizing gas supply passage 62 via an adjusting valve 70. The nitrogen tank 72 can supply nitrogen to the oxidizing gas supply passage 62 in an amount corresponding to the opening degree of the adjusting valve 70.

The oxidizing gas supply passage 62 is equipped with a bubbler 74. The bubbler 74 is a humidifier with which a heater 76 and a temperature gauge 78 are incorporated. The bubbler 74 can create a saturation state of water vapors at a set temperature. For example, when the set temperature is 40° C., oxidizing gas flowing into the membrane electrode assembly piece 60 can be humidified to assume a saturation state at 40° C.

A pressure gauge 80 and a heater 82 are disposed downstream of the bubbler 74. As described above, the membrane electrode assembly piece 60 has such a size that the distribution of pressure and the like therein can be ignored. Therefore, a measured value of the pressure gauge 80 can be handled as the pressure P_Ca (homogeneous value) of the cathode of the membrane electrode assembly piece 60.

The heater 82 is provided to prevent dew condensation at a pre-stage of the membrane electrode assembly piece 60. According to this configuration, oxidizing gas humidified by the bubbler 74 can be supplied to the membrane electrode assembly piece 60 without causing any change in humidity. Therefore, according to the system shown in FIG. 5, the humidity of oxidizing gas supplied to the membrane electrode assembly piece 60 can be rather accurately controlled.

Oxidizing gas supplied to the cathode of the membrane electrode assembly piece 60 flows out from the oxidizing gas discharge passage 64. The oxidizing gas discharge passage 64 is provided with a dew point meter 84. The dew point meter 84 can accurately measure the humidity of oxidizing gas flowing out from the membrane electrode assembly piece 60.

The system shown in FIG. 5 is equipped with a fuel gas supply passage 86 and a fuel gas discharge passage 88 that communicate with the anode side of the membrane electrode assembly piece 60. A hydrogen tank 92 communicates with the fuel gas supply passage 86 via an adjusting valve 90. According to this configuration, hydrogen gas can be supplied at a desired pressure to the membrane electrode assembly piece 60 by controlling the opening degree of the adjusting valve 90.

The fuel gas supply passage 86 is equipped with a bubbler 94 downstream of the adjusting valve 90. As is the case with the bubbler 74 on the cathode side, the bubbler 94 is equipped with a heater 96 and a temperature gauge 98, and can humidify fuel gas to form a saturation state under a set temperature.

A pressure gauge 100 and a heater 102 are disposed downstream of the bubbler 94: A measured value of the pressure gauge 100 can be handled as the pressure P_An (homogeneous value) of the anode of the membrane electrode assembly piece 60. The heater 102 can prevent dew condensation at the pre-stage of the membrane electrode assembly piece 60. According to this configuration, the humidity of fuel gas flowing into the anode of the membrane electrode assembly piece 60 can be rather accurately controlled.

Fuel gas supplied to the anode of the membrane electrode assembly piece 60 flows out from the fuel gas discharge passage 88. The fuel gas discharge passage 88 is provided with a dew point meter 104. The dew point meter 104 can accurately measure the humidity of fuel gas flowing out from the membrane electrode assembly piece 60.

A coolant supply passage 106 and a coolant discharge passage 108 communicate with the membrane electrode assembly piece 60. The coolant-discharge passage 108 is provided with a temperature gauge 110. The system shown in FIG. 5 can accurately control the temperature of coolant flowing through the membrane electrode assembly piece 60 by performing feedback of the measured value of the temperature gauge 110. In this system, the temperature of the coolant can be handled as the temperature of the membrane electrode assembly piece 60.

The system shown in FIG. 5 is further equipped with a measuring circuit 112 for coupling an anode-side electrode and a cathode-side electrode of the membrane electrode assembly piece 60 to each other. The measuring circuit 112 is equipped with an ammeter 114 and a variable resistance 116. According to this configuration, the amount of the current generated by the membrane electrode assembly piece 60 (the current density I) can be measured with the difference in potential generated between the anode-side electrode and the cathode-side electrode controlled to a desired value (e.g., 0.6 V or 0.8 V), by adjusting the variable resistance 116.

As described above, in order to create the maps shown in FIGS. 2 to 4, it is necessary to specify the power generation environment surrounding each of the membrane electrode assemblies. More specifically, it is necessary to specify the anode relative humidity An_RH, the cathode relative humidity Ca_RH, the cathode pressure P_Ca, the concentration of oxygen, and the temperature T.

The anode relative humidity An_RH and the cathode relative humidity Ca_RH can be calculated respectively according to arithmetic expressions shown below.

An_RH=(vapor pressure of fuel gas)/(saturated water vapor pressure at temperature T)×100 (1)

Ca_RH=(vapor pressure of oxidizing gas)/(saturated water vapor pressure at temperature T)×100 (2)

According to the system shown in FIG. 5, the temperature of coolant is equal to the “temperature T”. Therefore, the “saturated water vapor pressure” in the second term on the right side of each of the aforementioned expressions (1) and (2) can be decided by deciding that temperature. Then, according to this system, the “humidity of fuel gas” in the expression (1) and the “humidity of oxidizing gas” in the expression (2) can be arbitrarily changed by changing the temperatures of the bubblers 74 and 94. Therefore, according to the system shown in FIG. 5, the anode relative humidity An_RH and the cathode relative humidity Ca_RH of the membrane electrode assembly piece 60 can be easily and accurately controlled to arbitrary values.

The system shown in FIG. 5 can control the cathode pressure P_Ca to an arbitrary value by controlling the operational state of the compressor 66. In addition, the concentration of oxygen in oxidizing gas flowing into the membrane electrode assembly piece 60 can also be accurately controlled by adjusting the amount of nitrogen flowing into the oxidizing gas supply passage 62 by means of the adjusting valve 70. Thus, according to the system shown in FIG. 5, all the parameters to be specified in setting the maps shown in FIGS. 2 to 4 can be easily and accurately set.

Each of the membrane electrode assemblies 12 shown in FIG. 1 is required to generate a target electromotive force (about 0.6 V). Thus, the maps shown in FIGS. 2 to 4 need to define the “current density I”, the “resistance value R”, and the “transfer amount H₂O_m of water” respectively under a circumstance where each of the membrane electrode assemblies 12 generates the target electromotive force.

In the system shown in FIG. 5, the current density I can be measured by the ammeter 114 while adjusting the electromotive force of the membrane electrode assembly piece 60 by adjusting the variable resistance 116. The resistance value R of the membrane electrode assembly piece 60 can be calculated from a relationship between current and voltage at that time. In addition, the amount of water produced in the cathode is proportional to the current density I. Therefore, the production amount of water can be calculated if the current density I is known. Then, the amount H₂O_m of water transferring from the cathode to the anode inside the membrane electrode assembly piece 60 can be calculated if the humidity of oxidizing gas flowing into the cathode (i.e., the amount of water), the amount of water produced in the cathode, and the humidity of oxidizing gas flowing out from the cathode (i.e., the amount of water) are known.

That is, according to the system shown in FIG. 5, the current density I and the resistance value R can be measured and the transfer amount H₂O_m of water can be calculated by appropriately changing the power generation environment surrounding the membrane electrode assembly piece 60. Thus, when this system is used, the maps shown in FIGS. 2 to 4 can be rather accurately set through a simple processing.

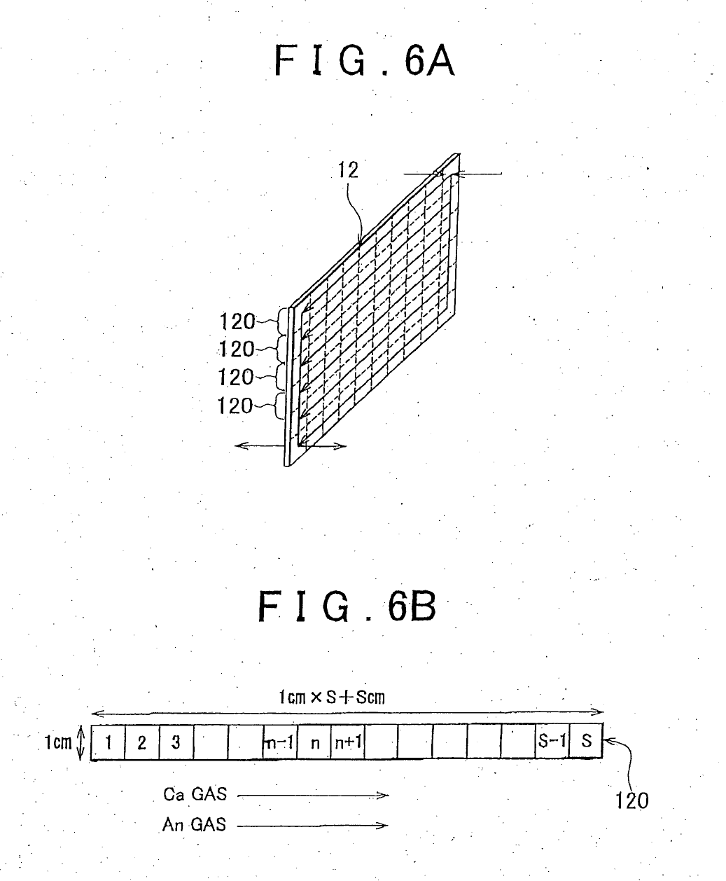

FIGS. 6A and 6B are views for explaining a method of virtually dividing each of the membrane electrode assemblies 12 with which the fuel cell 10 shown in FIG. 1 is equipped. More specifically, FIG. 6A is a perspective view showing an anode plane of each of the membrane electrode assemblies 12. As described above, the gas flow channels for causing fuel gas and oxidizing gas to flow therethrough respectively are formed inside each of the membrane electrode assemblies 12 on the anode side and the cathode side respectively. In this embodiment of the invention, these gas flow channels are formed so as to form the coflow flow channel, that is, such that fuel gas on the anode side and oxidizing gas on the cathode side proceed in the same direction (a direction indicated by arrows in FIG. 6A) from one end of each of the membrane electrode assemblies 12 to the other end thereof.

FIG. 6B shows one of band-like cutout portions (hereinafter referred to as “band-like portions 120”) of each of the membrane electrode assemblies 12. Each of the membrane electrode assemblies 12 can be virtually regarded as being composed of a plurality of these band-like portions arranged lengthwise. In each of the band-like portions 120, oxidizing gas on the cathode side and fuel gas on the anode side flow parallel to each other in a longitudinal direction as indicated by arrows in FIG. 6B.

As shown in FIG. 6B, each of the band-like portions 120 can be regarded as being composed of s small regions arranged in the direction in which the reactive gases flow. In this embodiment of the invention, these small regions have a size of 1 cm×1 cm as is the case with the membrane electrode assembly piece 60 shown in FIG. 5.

When consideration is given with each of the membrane electrode assemblies 12 decomposed into the small regions shown in FIG. 6B, the power generation environment can be regarded as homogeneous in each of the small regions. In this case, if a power generation environment in, for example, the (n−1)th small region (hereinafter referred to as the “n−1 region”) is known, a power generation state in that region can be predicted. Then, if the power generation environment and the power generation state in the n−1 region are known, a power generation environment in the n region can be predicted. Thus, when consideration is given with each of the membrane electrode assemblies 12 divided into the small regions shown in FIG. 6B, the knowledge of the power generation environment in the first small region makes it possible to thereafter predict sequentially the power generation environments and the power generation states in the respective small regions ending with the s region.

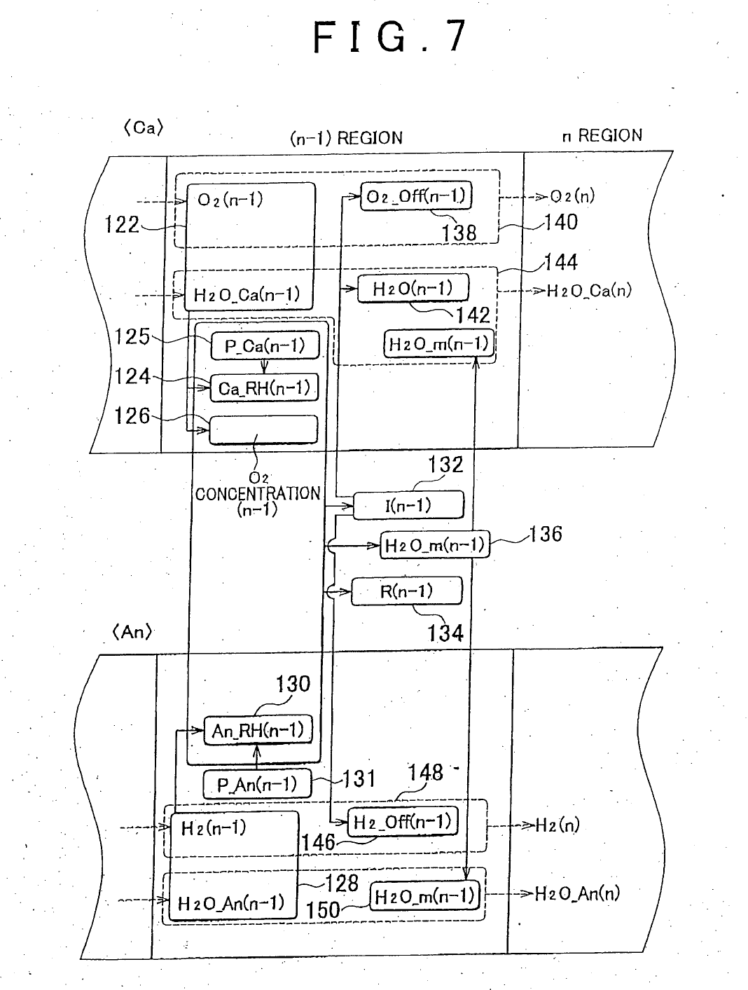

FIG. 7 is a diagram for explaining a procedure of predicting the power generation environment in the n region on the basis of the power generation environment in the n−1 region. Oxidizing gas flows into the cathode in the n−1 region from the cathode in the n−2 region, and water present in the cathode in the n−2 region flows into the cathode in the n−1 region. It is assumed herein that the amount O₂(n−1) of oxygen flowing in from the n−2 region and the amount H₂O_Ca(n−1) of water flowing in from the n−2 region are known (see reference numeral 122).

The cathode relative humidity Ca_RH can be calculated from the cathode pressure P_Ca, the amount H₂O_Ca of water in the cathode, and the amount of oxidizing gas (the amount N₂ of nitrogen+the amount O₂ of oxygen) according to an expression shown below.

Ca_RH=[P_Ca×H₂O_Ca/{(N₂+O₂)+H₂O_Ca}]/(saturated water vapor pressure)×100 (3)

All the parameters included in the right side of the aforementioned expression (3) can be specified in the n−1 region as will be described below. Accordingly, the cathode relative humidity Ca_RH in the n−1 region can be calculated using the aforementioned expression (3) (see reference numeral 124). Among the aforementioned parameters, the cathode pressure P_Ca(n−1) can be calculated through proportional calculation from measured values of the pressure gauges 36 and 40 at the inlet and the outlet on the cathode side of each of the membrane electrode assemblies 12 (see reference numeral 125). The amount H₂O_Ca(n−1) of water is known as described above. The amount N₂ of nitrogen can be regarded as constant during the flow thereof and hence can be calculated from the amount of air flowing into each of the membrane electrode assemblies 12. The amount O₂(n−1) of oxygen is known as described above. The saturated water vapor pressure can be specified from the temperature T detected by the temperature gauge 48.

The concentration of oxygen in oxidizing gas can be calculated from the amount N₂ of nitrogen and the amount O₂ of oxygen according to an expression shown below.

concentration of oxygen=O₂/(N₂+O₂) (4)

Accordingly, the concentration of oxygen in the n−1 region (O₂ concentration (n−1)) can be calculated from the amount N₂ of nitrogen flowing into each of the membrane electrode assemblies 12 and the amount O₂(n−1) of oxygen flowing in from the n−2 region (see reference numeral 126).

Fuel gas flows into the anode in the n−1 region from the anode in the n−2 region, and water present in the anode in the n−2 region flows into the anode in the n−1 region. It is assumed herein that the amount H₂(n−1) of hydrogen flowing in from the n−2 region and the amount H₂O_An(n−1) of water flowing in from the n−2 region are known (see reference numeral 128).

The anode relative humidity An_RH can be calculated from the anode pressure P_An, the amount H₂O_An of water in the anode, and the amount H₂ of hydrogen according to an expression shown below.

An_RH={P_An×H₂O_An/(H₂+H₂O_An)}/(saturated water vapor pressure)×100 (5)

All the parameters included in the right side of the aforementioned expression (5) can be specified in the n−1 region as will be described below. Accordingly, the anode relative humidity Ca_An in the n−1 region can be calculated by using the aforementioned expression (5) (see reference numeral 130). Among the aforementioned parameters, the anode pressure P_An(n−1) can be calculated through proportional calculation from measured values of the pressure gauges 42 and 46 at the inlet and the outlet on the anode side of each of the membrane electrode assemblies 12 (see reference numeral 131). The amount H₂O_An(n−1) of water and the amount H₂(n−1) of hydrogen are known as described above. The saturated water vapor pressure can be specified from the temperature T detected by the temperature gauge 48.

If the anode relative humidity An_RH(n−1) (130), the cathode relative humidity Ca_RH(n−1) (124), and the concentration O₂(n−1) of oxygen (126) are known, the current density I under the cathode pressure P_Ca=140 kPa can be read out from the map shown in FIG. 2A. The current density I under the cathode pressure P_Ca=200 kPa can be read out from the map shown in FIG. 2B.

On the other hand, the cathode pressure P_Ca(n−1) in the n−1 region can be calculated as described above through proportional calculation using the measured values of the pressure gauges 36 and 40. The current density I is proportional to the cathode pressure P_Ca. Therefore, the current density I(n−1) in the n−1 region can be calculated through proportional calculation on the basis of the current densities I read out from the maps shown in FIGS. 2(A) and 2(B) respectively (see reference numeral 132).

By the same token, the resistance value R in the n−1 region can be calculated by referring to the maps shown in FIGS. 3(A) and 3(B) (see reference numeral 134). Furthermore, the transfer amount H₂O_m of water in the n−1 region can be calculated by referring to the maps shown in FIGS. 4(A) and 4(B) (see reference numeral 136).

Oxygen is consumed in an amount corresponding to the current density I on the cathode side of each of the membrane electrode assemblies 12. This consumption amount O₂_{_{—}}off of oxygen can be calculated from an expression shown below. It should be noted that F in the expression shown below represents a Faraday constant.

O₂_{_{—}}off=I/4/F×22.4×60 (6)

Accordingly, if the current density I(n−1) in the n−1 region is known, the consumption amount O₂_{_{—}}off(n−1) of oxygen on the cathode side in that region can be calculated (see reference numeral 138). The amount O₂(n) of oxygen flowing out from the n−1 region into the n region is an amount obtained by subtracting the amount O₂_{_{—}}off(n−1) of oxygen consumed in the n−1 region from the amount O₂(n−1) of oxygen flowing into the n−1 region, and hence can be calculated according to an expression shown below (see reference numeral 140).

O₂(n)=O₂(n−1)−O₂_{_{—}}off(n−1) (7)

Water is produced in an amount corresponding to the current density I on the cathode side of each of the membrane electrode assemblies 12. This production amount H₂O of water can be calculated according to an expression shown below.

H₂O=I/2/F×22.4×60 (8)

Accordingly, if the current density I(n−1) in the n−1 region is known, the amount H₂O(n−1) of water produced in the cathode in that region can be calculated (see reference numeral 142). The amount H₂O_Ca(n) of water flowing out from the n−1 region into the cathode in the n region is an amount obtained by subtracting the amount H₂O_m(n−1) of water transferring from the cathode to the anode in the n−1 region from a sum of the amount H₂O_Ca(n−1) of water flowing into the n−1 region and the amount H₂O(n−1) of water produced in the n−1 region, and hence can be calculated through an expression shown below (see reference numeral 144).

H₂O_Ca(n)=H₂O_{—}⁻Ca(n−1)+H₂O(n−1)−H₂O_{—}m(n−1) (9)

Next, the prediction of the power generation state on the anode side will be described. That is, hydrogen is consumed in an amount corresponding to the current density I on the anode side of each of the membrane electrode assemblies 12. This consumption amount H₂_{_{—}}off of hydrogen can be calculated according to an expression shown below.

H₂_{_{—}}off=I/2/F×22.4×60 (10)

Accordingly, if the current density I(n−1) in the n−1 region is known, the consumption amount H₂_{_{—}}off(n−1) of hydrogen on the anode side in that region can be calculated (see reference numeral 146). The amount H₂(n) of hydrogen flowing out from the n−1 region into the n region is an amount obtained by subtracting the amount H₂_{_{—}}off(n−1) of hydrogen consumed in the n−1 region from the amount H₂(n−1) of hydrogen flowing into the n−1 region, and hence can be calculated according to an expression shown below (see reference numeral 148).

H₂(n)=H₂(n−1)−H₂_{_{—}}off(n−1) (11)

The amount of water in the anode increases by the amount of water transferring from the cathode side. Thus, the amount H₂O_An(n) of water flowing out from the n−1 region into the anode in the n region is an amount obtained by adding the transfer amount H₂O_m(n−1) of water in the n−1 region to the amount H₂O_An(n−1) of water flowing into the n−1 region. This amount H₂O_An(n) of water can be calculated according to an expression shown below (see reference numeral 150).

H₂O_An(n)=H₂O_An(n−1)+H₂O_{—}m(n−1) (12)

As described above, the foregoing processing makes it possible to predict the power generation state in the n−1 region if the power generation environment in that region is known. More specifically, the current density I(n−1), the resistance value R(n−1), and the transfer amount H₂O_m of water in the n−1 region can be calculated if the amount O₂(n−1) of oxygen flowing into the cathode in the n−1 region, the amount H₂O_Ca(n−1) of water flowing into the cathode in the n−1 region, the amount H₂(n−1) of hydrogen flowing into the anode in the n−1 region, the amount H₂O_An(n−1) of water flowing into the anode in the n−1 region, the cathode pressure P_Ca in the n−1 region, and the anode pressure P_An in the n−1 region are known.

When the power generation state predicted through the foregoing processing is reflected on the power generation environment in the n−1 region, the power generation environment in the n region as a subsequent stage can be specified. Thus, according to the foregoing processing, the specification of only the power generation environment in the first small region makes it possible to sequentially calculate the power generation environments and the power generation states in the respective small regions ending with the s region.

In the system shown in FIG. 1, the amount O₂(1) of oxygen flowing into the cathode in the first region can be calculated by multiplying the amount of air force-fed by the compressor 20 by the concentration of oxygen in air (known). The amount H₂O_Ca(1) of water flowing into the cathode in the first region can be calculated on the basis of the output of the dew point meter 38 on the cathode side.

The amount H₂(1) of hydrogen flowing into the anode in the first region can be detected on the basis of the opening degree of the adjusting valve 28 or the like. The amount H₂O_An(1) of water flowing into the anode in the first region can be calculated on the basis of the output of the dew point meter 44 on the anode side.

In addition, the cathode pressure P_Ca in the first region can be calculated by performing proportional calculation on the basis of the output of the pressure gauge 36 at the inlet of the cathode and the output of the pressure gauge 40 at the outlet of the cathode. By the same token, the anode pressure P_An in the first region can be calculated by performing proportional calculation on the basis of the output of the pressure gauge 42 at the inlet of the anode and the output of the pressure gauge 46 at the outlet of the anode.

As described above, the system shown in FIG. 1 makes it possible to acquire all the numerical values necessary for predicting the power generation state in the first region. Accordingly, the system of this embodiment of the invention makes it possible to predict through calculation in what power generation state and under what power generation environment each of the regions constituting each of the membrane electrode assemblies 12, namely, each of the regions ranging from the first region to the s region is.

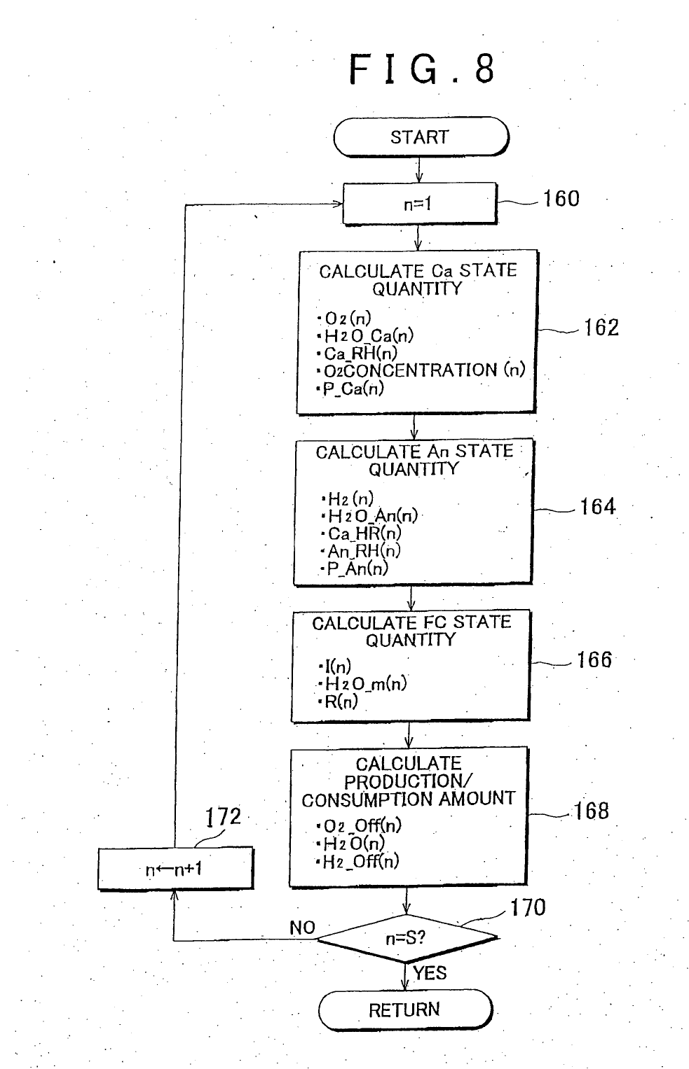

FIG. 8 is a flowchart of a routine executed by the ECU 50 to realize the aforementioned processing. In the routine shown in FIG. 8, a region number n is first set to 1 (step 160).

A cathode state quantity in the region n is then calculated (step 162). More specifically, the amount O₂(n) of oxygen flowing into the cathode in the region n=1 and the amount H₂O_Ca(n) of water flowing into the cathode in the region n=1 are calculated (see reference numeral 122 in FIG. 7). The cathode pressure P_Ca(n) is then calculated through proportional calculation based on the outputs of the pressure gauges 36 and 40 (see reference numeral 125 in FIG. 7). In addition, the cathode relative humidity Ca_RH(n) and the concentration O₂(n) of oxygen in the cathode are calculated according to the aforementioned expressions (3) and (4) respectively (see reference numerals 124 and 126 in FIG. 7).

In the routine shown in FIG. 8, an anode state quantity in the region n is then calculated (step 164). More specifically, the amount H₂(n) of hydrogen flowing into the anode in the region n=1 and the amount H₂O_An(n) of water flowing into the anode in the region n=1 are calculated (see reference numeral 128 in FIG. 7). The anode pressure P_An(n) is then calculated through proportional calculation based on the outputs of the pressure gauges 42 and 46 (see reference numeral 131 in FIG. 7). In addition, the anode relative humidity An_RH(n) is calculated according to the aforementioned expression (5) (see reference numeral 130 in FIG. 7).

A power generation state in the n region, namely, a state quantity of the fuel cell in the n region is calculated (step 166). More specifically, the current densities I are first read out from the maps shown in FIGS. 2(A) and 2(B) respectively. More specifically, the current density I in the case where the cathode pressure P_Ca is 140 kPa is read out from the map shown in FIG. 2A. The current density I in the case where the cathode pressure P_Ca is 200 kPa is read out from the map shown in FIG. 2B. In this step, the current density I corresponding to the cathode pressure P_Ca(n) is calculated by subjecting those map values to proportional calculation (see reference numeral 132 in FIG. 7).

In the aforementioned step 166, the resistance value R(n) is calculated by referring to the maps shown in FIGS. 3(A) and 3(B) (see reference numeral 134 in FIG. 7). In addition, the transfer amount H₂O_m(n) of water is calculated by referring to the maps shown in FIGS. 4(A) and 4(B) (see reference numeral 136 in FIG. 7). The method of calculating the resistance value R(n) corresponding to the cathode pressure P_Ca(n) and the transfer amount H₂O_m(n) of water corresponding to the cathode pressure P_Ca(n) from the two map values is the same as in the case of the current density I, and hence will not be described below in detail.

Amounts of production and consumption in the n region are then calculated (step 168). More specifically, the amount O₂_{_{—}}off(n) of oxygen consumed on the cathode side and the amount H₂O(n) of produced water are calculated according to the aforementioned expressions (6) and (8) respectively (see reference numerals 138 and 142 in FIG. 7). In addition, the amount H₂_{_{—}}off(n) of hydrogen consumed on the anode side is calculated according to the aforementioned expression (10) (see reference numeral 146 in FIG. 7).

When the foregoing processings are terminated, it is determined whether or not the region number n has reached a final value s (step 170). When it is determined as a result that the region number n has not reached s, the region number n is incremented (step 172), and the processings starting from the aforementioned step 162 are performed again.

When the region number n is equal to or larger than 2, the amount O₂(n) of oxygen in the cathode and the amount H₂O_Ca of water in the cathode are calculated according to the aforementioned expressions (7) and (9) respectively in step 162 (see reference numerals 140 and 144 in FIG. 7). In this case, the amount H₂(n) of hydrogen in the anode and the amount H₂O_An of water in the anode are calculated according to the aforementioned expressions (11) and (12) respectively in step 164.

After that, the aforementioned processings are repeatedly performed until it is determined in step 170 that a relationship: n=s is established. As a result, the power generation environments and the power generation states in all the regions ranging from the first region to the s region are calculated. That is, according to the aforementioned processings, the distribution of power generation environment and power generation state in each of the membrane electrode assemblies 12 can be predicted using the aforementioned small regions as mesh unit.

In the foregoing first embodiment of the invention, the temperature of each of the membrane electrode assemblies 12 is homogeneous over the entire plane thereof. However, the invention is not limited to this feature. That is, in the case where the temperature of each of the membrane electrode assemblies 12 is distributed in the plane, the distribution of power generation state may be predicted in consideration of the distribution of the temperature. The prediction taking the distribution of the temperature into account can be realized according to, for example, the following method.

Maps regarding the current density I, the resistance value R, and the transfer amount H₂O_m of water are prepared respectively for a plurality of temperatures. The respective maps are set by measuring the current density I, the resistance value R, and the transfer amount H₂O_m of water while changing the temperature of the membrane electrode assembly piece 60 (see FIG. 5). The temperature in each of the small regions of each of the membrane electrode assemblies 12 is predicted by reflecting the amount of heat generation in that one of the small regions which is located upstream of the flow of the reactive gases on the temperature in that region. The amount of heat generation is calculated on the basis of the current density I in that region. When the temperature in that region is known, the current density I, the resistance value R, and the transfer amount H₂O_m of water that correspond to the temperature in that region are calculated through proportional calculation on the basis of map values read out from the plurality of the maps prepared for the respective temperatures.

In the foregoing first embodiment of the invention, the distribution of the resistance value R of each of the membrane electrode assemblies 12 is also predicted. However, the prediction of the resistance value R may be omitted if not necessary.

In the foregoing first embodiment of the invention, the measurement using the membrane electrode assembly piece 60 (see FIG. 5) is carried out with a view to simplifying the operation of setting the maps. However, the method of setting the maps shown in FIGS. 2 to 4 is not limited to this measurement. For example, the operation of setting the maps may be performed using each of the membrane electrode assemblies 12 as an object to be measured.

In the foregoing first embodiment of the invention, the dew point meter 44 is disposed at the inlet on the anode side as well in case that humidified hydrogen gas is supplied to the anode of the fuel cell 10. However, the invention is not limited to this configuration. That is, the aforementioned dew point meter 44 may be omitted in the case where fuel gas supplied to the anode is not humidified.

In the foregoing first embodiment of the invention, the pressure gauges 42 and 46 are disposed at two spots, namely, the inlet and the outlet respectively so as to predict the anode pressure P_An. However, the invention is not limited to this configuration. That is, the distribution of pressure inside each of the membrane electrode assemblies 12 can be estimated if the pressure at one of the inlet and the outlet is known. Thus, only one of the pressure gauges may be disposed on the anode side at one of the inlet side and the outlet side. In this respect, the same holds true for the pressure gauges on the cathode side.

In the foregoing first embodiment of the invention, the ECU 50 may have stored therein the maps shown in FIGS. 2 A and 2B to realize the “power generation characteristic storing means”. The ECU 50 may have stored therein the aforementioned expressions (6), (8), and (10) to realize the “consumption production characteristic storing means”. The compressor 20, the humidifier 18, the adjusting valve 28, and the hydrogen tank 30 may correspond to the “inlet environment deciding means”. The ECU 50 may carry on the calculation processings with each of the membrane electrode assemblies 12 divided into the aforementioned small regions to realize the “small region defining means”. The ECU 50 may calculate the current density I(n) in step 166 to realize the “power generation amount calculating means”, and may perform the processing of step 168 to realize the “consumption production amount calculating means”. In addition, the ECU 50 may calculate the amount O₂(n) of oxygen and the amount H₂O_Ca(n) of water according to the aforementioned expressions (7) and (9) respectively in step 162 and calculate the amount H₂(n) of hydrogen and the amount H₂O_An(n) of water according to the aforementioned expressions (11) and (12) respectively in step 164 to realize the “power generation environment updating means”.

In the foregoing first embodiment of the invention, the ECU 50 may have stored therein the maps shown in FIGS. 3A and 3B to realize the “resistance characteristic storing means”. The ECU 50 may calculate the resistance value R(n) in step 166 to realize the “resistance value calculating means”.

In the foregoing first embodiment of the invention, the ECU 50 may have stored therein the maps shown in FIGS. 4A and 4B to realize the “water transfer characteristic storing means”. The ECU 50 may calculate the transfer amount H₂O_m(n) of water in step 166 to realize the “water transfer amount calculating means”. Furthermore, the ECU 50 may calculate the amount H₂O_Ca(n) of water according to the aforementioned expression (9) in step 162 to realize the “cathode water amount updating means”, and may calculate the amount H₂O_An(n) of water according to the aforementioned expression (12) in step 164 to realize the “anode water amount updating means”.

In the foregoing first embodiment of the invention, the ECU 50 may calculate the consumption amount O₂_{_{—}}off(n) of oxygen according to the aforementioned expression (6) in step 168 to realize the “oxygen consumption amount calculating means”, and may calculate the consumption amount H₂_{_{—}}off(n) of hydrogen according to the aforementioned expression (10) in step 168 to realize the “hydrogen consumption amount calculating means”. Furthermore, the ECU 50 may calculate the amount O₂(n) of oxygen according to the aforementioned expression (7) in step 162 to realize the “oxygen amount updating means”, and may calculate the amount H₂(n) of hydrogen according to the aforementioned expression (11) in step 164 to realize the “hydrogen amount updating means”.

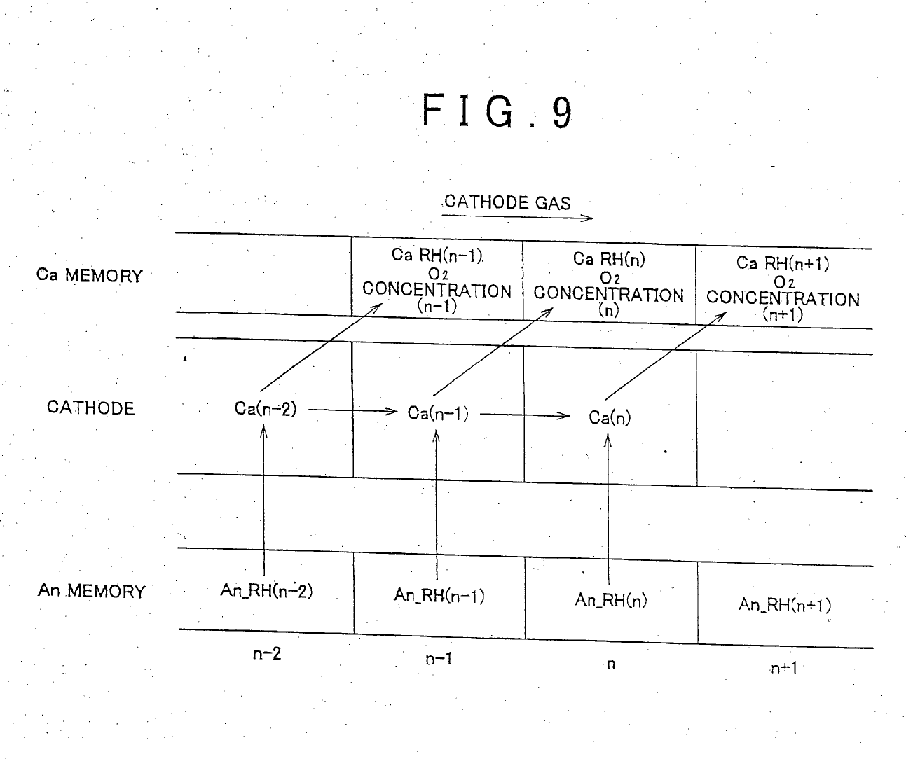

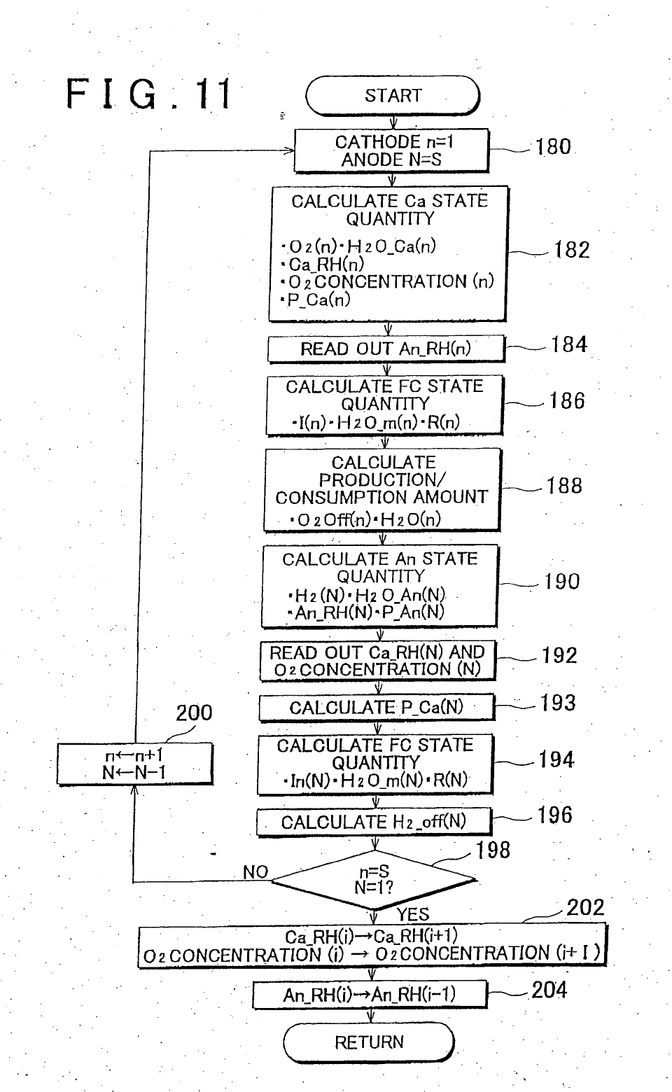

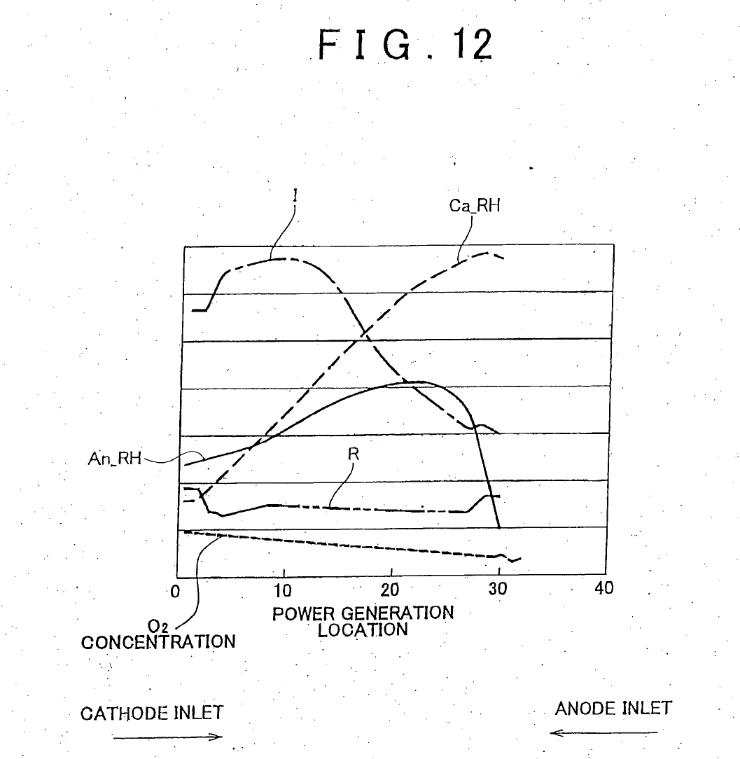

Next, the second embodiment of the invention will be described with reference to FIGS. 9 to 12. The hardware configuration of this embodiment of the invention is identical to the configuration shown in FIG. 1 except in that the oxidizing gas flow channel and the fuel gas flow channel of each of the membrane electrode assemblies 12 form a counter flow channel. The system according to this embodiment of the invention is realized by causing the ECU 50 to execute a later-described routine shown in FIG. 11 in this hardware configuration.

As described above, in the system according to the first embodiment of the invention, the oxidizing gas flow channel and the fuel gas flow channel of each of the membrane electrode assemblies 12 form the coflow flow channel. That is, in the first embodiment of the invention, oxidizing gas on the cathode side and fuel gas on the anode side flow in the same direction. In this case, the power generation environment and the power generation state in the n−1 region decide the power generation environment in the n region on both the anode side and the cathode side. Thus, in the system according to the first embodiment of the invention, the power generation environment and the power generation state in the first region can be predicted on the basis of the states of the inlet of the anode and the inlet of the cathode. After that, the power generation environments and the power generation states can be sequentially predicted for the respective small regions ending with the s region.

However, in the case where the fuel passage on the cathode side and the fuel passage on the anode side form the counter flow channel, if it is assumed that the inlet of the cathode leads to the first region, the inlet of the anode leads to the s region. In this case, the state in the n−1 region decides the state in the n region on the cathode side, whereas the state in the n+1 region decides the state in the n region on the anode side.

For example, if it is assumed in both the cathode and the anode that prediction is started from that one of the small regions which is adjacent to the inlet, the power generation state in the first small region is first predicted on the basis of the state of the cathode inlet on the cathode side. On the other hand, the power generation state in the s region is predicted on the basis of the state of the anode inlet at that timing on the anode side. That is, at this timing, although the power generation environment on the cathode side in the first region can be predicted, the power generation environment on the anode side in the first region cannot be predicted. The opposite situation occurs in the s region.

As described with reference to FIG. 7, the current density I(n−1), the resistance value R(n−1), and the transfer amount H₂O_m(n−1) of water in a certain one of the small regions (the (n−1) region) cannot be predicted unless the environment on the cathode side in that region and the environment on the anode side in that region are both specified. If the current density I(n−1) and the transfer amount H₂O_m(n−1) of water are not decided, the consumption amount O₂_{_{—}}off(n−1) of oxygen in the (n−1) region, the consumption amount H₂_{_{—}}off(n−1) of hydrogen in the (n−1) region, and the production amount H₂O(n−1) of water in the (n−1) region cannot be predicted. Thus, in the case where the oxidizing gas passage and the fuel gas passage form the counter flow channel, the power generation environments and the power generation states in all of the plurality of the small regions cannot be sequentially predicted according to the same method as in the first embodiment of the invention.

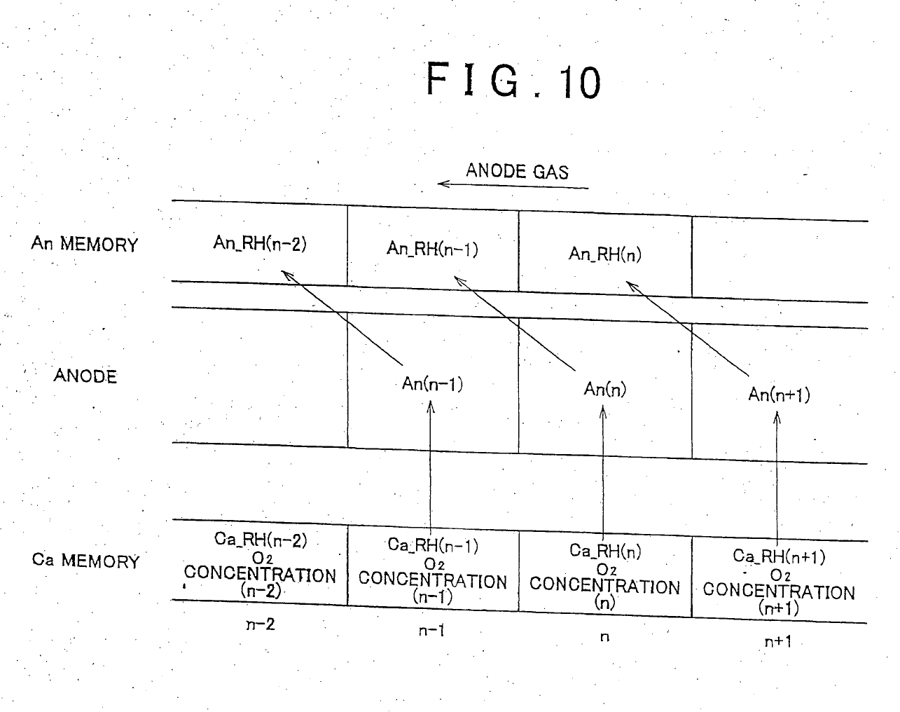

FIGS. 9 and 10 are diagrams for explaining a method of predicting power generation environments and power generation states in the respective small regions in the case where the oxidizing gas passage and the fuel gas passage form the counter flow channel. More specifically, FIG. 9 is a diagram for explaining a method of sequentially predicting power generation environments and power generation states on the cathode side. FIG. 10 is a diagram for explaining a method of sequentially predicting power generation environments and power generation states on the anode side.

In this embodiment of the invention, the ECU 50 has a cathode memory region (see the upper stage of FIG. 9 and the lower stage of FIG. 10) and an anode memory region (see the lower stage of FIG. 9 and the upper stage of FIG. 10). The cathode memory region serves to store the cathode relative humidity Ca_RH and the concentration O₂ of oxygen in each of the small regions. On the other hand, the anode memory region serves to store the anode relative humidity An_RH in each of the small regions.

As shown in FIG. 9, the ECU 50 has stored in the anode memory region the anode relative humidity An_RH corresponding to each of the small regions. As described with reference to FIG. 7, the current density I(i), the resistance value R(i), and the transfer amount H₂O_m(i) of water in a certain one of the small regions (an i region) can be calculated if the anode relative humidity An_RH(i) can be specified in addition to the power generation environment on the cathode side. Thus, if the power generation environment on the cathode side in the i region can be specified, the power generation state in the i region can be predicted by reading out the anode relative humidity An_RH(i) from the anode memory region. In addition, the power generation environment in the (i+1) region located at a subsequent stage can be predicted. By repeating this processing, the power generation environments and the power generation states in all the small regions ranging from the first small region to the s region can be sequentially predicted.

In this embodiment of the invention, the ECU 50 calculates the power generation environments on the cathode side in the respective small regions and the power generation states in the respective small regions according to the order corresponding to the flow of oxidizing gas on the cathode side, through the aforementioned method. In this process of calculation, a cathode relative humidity Ca_RH(i) and a concentration O₂(i) of oxygen are calculated in each of the small regions (i). As shown in FIG. 9, the ECU 50 stores the cathode relative humidity Ca_RH(i) and the concentration O₂(i) Of oxygen, which have thus been calculated, into the cathode memory region as data on the subsequent stage, namely, as data on the i+1 region.

FIG. 10 shows a procedure according to which the ECU 50 sequentially calculates each of the states on the anode side using the cathode relative humidity Ca_RH and the concentration O₂ of oxygen that are stored in the cathode memory region. That is, if the cathode relative humidity Ca_RH(i) and the concentration O₂(i) of oxygen as well as the power generation environment on the anode side can be specified in the i region, the ECU 50 can calculate the current density I(i), the resistance value R(i), and the transfer amount H₂O_m(i) of water. Thus, if the power generation environment on the anode side in the i region can be specified, the power generation state in the i region can be predicted by reading out the cathode relative humidity Ca_RH(i) and the concentration O₂(i) of oxygen from the cathode memory region. In addition, the power generation environment in an (i−1) region located at the previous stage can be predicted. By repeating this processing, the power generation environments and the power generation states in all the small regions ranging from the s region to the first region can be sequentially predicted.

In this embodiment of the invention, the ECU 50 calculates the power generation environments on the anode side in the respective small regions and the power generation states in the respective small regions according to the order corresponding to the flow of fuel gas on the anode side, through the aforementioned method. In this process of calculation, the anode relative humidity An_RH(i) is calculated in each of the small regions (i). As shown in FIG. 10, the ECU 50 stores the anode relative humidity An thus calculated into the anode memory region as data on the previous stage, namely, as data on the i−1 region.

As described above, in this embodiment of the invention, the ECU 50 performs the processings of sequentially predicting the power generation environments and the power generation states on both the cathode side and the anode side in parallel with each other. The processing, on the cathode side is performed using the anode relative humidity An_RH stored in the anode memory region one cycle earlier. On the other hand, the processing on the anode side is performed using the cathode relative humidity Ca_RH and the concentration O₂ of oxygen that are stored in the cathode memory region one cycle earlier.

Accordingly, the prediction processing using the power generation environment on the cathode side at a time t1 and the anode relative humidity An_RH at a time t0, which is one cycle earlier than the time t1, is performed on the cathode side at the time t1. By the same token, the prediction processing using the power generation environment on the anode side at the time t1, the cathode relative humidity Ca_RH at the time t0, and the concentration O₂ of oxygen at the time t0 is performed on the anode side.

In this embodiment of the invention, in order to exclude the influence of the aforementioned time difference, the cathode relative humidity Ca_RH(i) and the concentration O₂ (i) of oxygen that are obtained in the i region are stored into the cathode memory region as data on the (i+1) region. On the cathode side, as oxidizing gas flows, the state in the i region shifts to the subsequent stage side with the lapse of time. Thus, if the data obtained in the i region are stored as data on the i+1 region, the aforementioned influence of the time difference corresponding to one cycle can be restricted. For the same reason, on the anode side as well, the influence of the time difference corresponding to one cycle can be sufficiently restricted through the method according to this embodiment of the invention. Therefore, according to the system of this embodiment of the invention, the power generation environments and the power generation states can be accurately predicted through the processing on the cathode side and the processing on the anode side.

FIG. 11 is a flowchart of the routine executed by the ECU 50 in this embodiment of the invention. In the routine shown in FIG. 11, first of all, the region numbers are initialized (step 180). More specifically, the region number n representing the object to be processed on the cathode side is set to 1. A region number N representing the object to be processed on the anode side is set to s.

A cathode state quantity in the n region (the first region) is then calculated (step 182). Iii this step 182, the amount O₂(n) of oxygen in the cathode, the amount H₂O_Ca(n) of water in the cathode, the cathode relative humidity Ca_RH(n), the concentration O₂(n) of oxygen in the cathode, and the cathode pressure P_Ca(n) are calculated through the same processing as in step 162 shown in FIG. 8 (see reference numerals 122, 124, 125, and 126 in FIG. 7).

The anode relative humidity An_RH(n) corresponding to the n region is then read out from the anode memory region (step 184).

The power generation state in the n region is then calculated (step 186). As described with reference to FIG. 7, if the anode relative humidity An_RH(n) (see reference numeral 130 in FIG. 7) is decided in addition to the power generation environment on the cathode side, the current density I(n), the resistance value R(n), and the transfer amount H₂O_m(n) of water can be read out from the maps shown in FIGS. 2 to 4. In this case, those values are read out from the maps on the basis of the parameters specified through the aforementioned processings of steps 182 and 184.

The amount O₂_{_{—}}off(n) of oxygen consumed on the cathode side and the amount H₂O(n) of water produced on the cathode side are then calculated (step 188). The consumption amount O₂_{_{—}}off(n) of oxygen is calculated according to the aforementioned expression (6). The production amount H₂O(n) of water is calculated according to the aforementioned expression (8) (see reference numerals 138 and 142 in FIG. 7).

The anode state quantity in the N region (the s region) is then calculated (step 190). In this step 190, the amount H₂(N) of hydrogen in the anode, the amount H₂O_An(N) of water in the anode, the anode relative humidity An_RH(N), and the anode pressure P_An(N) are calculated through the same processing as in step 164 shown in FIG. 8 (see reference numerals 128, 130, and 131 in FIG. 7).

The cathode relative humidity Ca_RH(N) corresponding to the N region is then read out from the cathode memory region (step 192). In addition, the cathode pressure P_Ca(N) is calculated on the basis of the outputs of the pressure gauges 36 and 40 on the cathode side (step 193).

The power generation state in the N region is then calculated (step 194). As described with reference to FIG. 7, if the cathode relative humidity Ca_RH(N), the cathode pressure P_Ca(N), and the concentration O₂(N) of oxygen are decided in addition to the power generation environment on the anode side (see reference numerals 124, 125, and 126 in FIG. 7), the current density I(N), the resistance value R(N), and the transfer amount H₂O_m(N) of water can be read out from the maps shown in FIGS. 2 to 4. In this case, those values are read out from the maps on the basis of the parameters specified through the aforementioned processings of steps 190 to 193.

The amount H₂_{_{—}}off(N) of hydrogen consumed on the anode side is then calculated (step 196). The consumption amount H₂_{_{—}}off(N) of hydrogen is calculated according to the aforementioned expression (10) (see reference numeral 146 in FIG. 7).

When the foregoing processings are terminated, it is determined whether or not the region number n on the cathode side has reached s and whether or not the region number N on the anode side has reached 1 (step 198). When this determination is negative as a result, the region number n is incremented and the region number N is decremented (step 200). After that, the aforementioned processings starting from step 182 are performed.

When the region number n is equal to or larger than 2, the amount O₂(n) of oxygen in the cathode and the amount H₂O_Ca of water in the cathode are calculated according to the aforementioned expressions (7) and (9) respectively in step 182 (see reference numerals 140 and 144 in FIG. 7). In this case, the amount H₂(n) of hydrogen in the anode and the amount H₂O_An of water in the anode are calculated according to the aforementioned expressions (11) and (12) respectively in step 190.

After that, the foregoing processings are repeatedly performed until it is determined in step 198 that relationships: n=s and N=1 are established. As a result, the power generation environments and the power generation states are calculated in all the regions ranging from the first region to the s region.

When the processings corresponding to one cycle are terminated on both the cathode side and the anode side after the repetition of the foregoing processings, the condition of step 198 is fulfilled. In this case, the ECU 50 then stores the cathode relative humidity Ca_RH(i) in the i region (i=1 to s) and the concentration O₂(i) of oxygen in the i region (i=1 to s) into the cathode memory region as data on the (i+1) region (step 202).

Furthermore, the ECU 50 stores the anode relative humidity An_RH(i) in the i region (i=1 to s) into the anode memory region as data on the (i−1) region (step 204). The processings described with reference to FIG. 9 are realized through the foregoing processings. As a result, preparations are made to accurately predict the power generation environments and the power generation states on both the cathode side and the anode side during a subsequent processing cycle.

According to the routine shown in FIG. 11, the power generation state on which the power generation environment on the cathode side is reflected on a real-time basis is calculated in step 186. The power generation state on which the power generation environment on the anode side is reflected on a real-time basis is calculated in the aforementioned step 194. These two power generation states eventually converge to substantially the same value through the repetition of predictive calculation. The distribution of power generation environment and power generation state at the time when those two power generation states have converged to the same value can be recognized as the distribution in a steady state. Thus, in the case where the system according to this embodiment of the invention is used, predictive calculation may be ended as soon as the power generation state obtained in step 186 and the power generation state obtained in step 194 become equivalent to each other.

FIG. 12 is a result of the prediction of distribution made by the system according to this embodiment of the invention. In FIG. 12, for example, the concentration O₂ of oxygen substantially proportionally decreases with increases in the distance from the inlet of the cathode. The current density I demonstrates a tendency to temporarily increase and then decrease with increases in the distance from the inlet of the cathode. The changes in these values accurately coincide with the tendency actually developed in each of the membrane electrode assemblies 12. The same holds true for the other values shown in FIG. 12 (the resistance value R, the anode relative humidity An_RH, and the cathode relative humidity Ca_RH). As indicated by these results of prediction, the system according to this embodiment of the invention makes it possible to accurately predict the distribution occurring in the plane of each of the membrane electrode assemblies 12.

In the foregoing second embodiment of the invention, the ECU 50 may calculate the current densities I(n) in steps 186 and 194 to realize the “power generation amount calculating means”, and may perform the processings of steps 188 and 196 to realize the “consumption production amount calculating means”. Furthermore, the ECU 50 may calculate the amount O₂(n) of oxygen and the amount H₂O_Ca(n) of water according to the aforementioned expressions (7) and (9) respectively in step 182 and calculate the amount H₂(n) of hydrogen and the amount H₂O_An(n) of water according to the aforementioned expressions (11) and (12) respectively in step 190 to realize the “power generation environment updating means”.

In the foregoing second embodiment of the invention, the ECU 50 may calculate the resistance values R(n) in steps 186 and 194 to realize the “resistance value calculating means”.

In the foregoing second embodiment of the invention, the ECU 50 may calculate the transfer amounts H₂O_m(n) of water in steps 186 and 194 to realize the “water transfer amount calculating means”. Furthermore; the ECU 50 may calculate the amount H₂O_Ca(n) of water according to the aforementioned expression (9) in step 182 to realize the “cathode water amount updating means”, and may calculate the amount H₂O_An(n) of water according to the aforementioned expression (12) in step 190 to realize the “anode water amount updating means”.

In the foregoing second embodiment of the invention, the ECU 50 may calculate the consumption amount O₂_{_{—}}off(n) of oxygen according to the aforementioned expression (6) in step 188 to realize the “oxygen consumption amount calculating means”, and may calculate the consumption amount H₂ off(n) of hydrogen according to the aforementioned expression (10) to realize the “hydrogen consumption amount calculating means”. Furthermore, the ECU 50 may calculate the amount O₂(n) of oxygen according to the aforementioned expression (7) in step 182 to realize the “oxygen amount updating means”, and may calculate the amount H₂(n) of hydrogen according to the aforementioned expression (11) in step 190 to realize the “hydrogen amount updating means”.

The invention has been described by dint of the preferred embodiments thereof. However, the invention is not limited to the disclosed embodiments thereof, but includes various modification examples and equivalents. In addition, the various elements of the disclosed invention are shown in various combinations and forms as an example. However, these elements belong to the scope of the invention even when they are combined or formed otherwise.

While the invention has been described with reference to what are considered to be preferred embodiments thereof, it is to be understood that the invention is not limited to the disclosed embodiments or constructions. On the contrary, the invention is intended to cover various modifications and equivalent arrangements. In addition, while the various elements of the disclosed invention are shown in various combinations and configurations, which are exemplary, other combinations and configurations, including more, less or only a single element, are also within the scope of the invention.

1. (canceled)

2. The fuel cell in-plane state estimating system according to claim 13, further comprising:
a resistance characteristic storing portion that stores a resistance characteristic defining a relationship between a resistance value and a power generation environment of the membrane electrode assembly; and
a resistance value calculating portion that calculates a resistance value in the first small region on a basis of the power generation environment of the second small region according to the resistance characteristic.

3. The fuel cell in-plane state estimating system according to claim 13, further comprising:
a water transfer characteristic storing portion that stores a water transfer characteristic defining a relationship between a transfer amount of water from the cathode of the membrane electrode assembly to the anode of the membrane electrode assembly and a power generation environment of the membrane electrode assembly; and
a water transfer amount calculating portion that calculates a transfer amount of water in the first small region on a basis of the power generation environment of the second small region according to the water transfer characteristic,
wherein:
the power generation environment includes an amount of water present in the cathode of the membrane electrode assembly and an amount of water present in the anode of the membrane electrode assembly; and
the power generation environment updating portion includes a cathode water amount updating portion that subtracts a transfer amount of water in the second small region from a sum of an amount of water present in the cathode in the second small region and a production amount of water in the second small region to calculate an amount of water present in the cathode in the first small region, and an anode water amount updating portion that adds the transfer amount of water in the second small region to an amount of water present in the anode in the second small region to calculate an amount of water present in the anode in the first small region.

4. The fuel cell in-plane state estimating system according to claim 13, wherein:
the reactive gas supplied to the cathode is oxidizing gas containing oxygen;
the reactive gas supplied to the anode is fuel gas containing hydrogen;
the consumption-production amount calculating portion includes an oxygen consumption amount calculating portion that calculates a consumption amount of oxygen in the cathode in each of the plurality of the small regions, and a hydrogen consumption amount calculating portion that calculates a consumption amount of hydrogen in the anode in each of the plurality of the small regions;
the power generation environment includes an amount of oxygen present in the cathode of the membrane electrode assembly, and an amount of hydrogen present in the anode of the membrane electrode assembly; and
the power generation environment updating portion includes an oxygen amount updating portion that subtracts a consumption amount of oxygen in the second small region from an amount of oxygen present in the cathode in the second small region to calculate an amount of oxygen present in the cathode in the first small region, and a hydrogen amount updating portion that subtracts a consumption amount of hydrogen in the second small region from an amount of hydrogen present in the anode in the second small region to calculate an amount of hydrogen present in the anode in the first small region.

5. The fuel cell in-plane state estimating system according to claim 13, wherein:
the membrane electrode assembly is equipped with a coflow flow channel through which the reactive gas supplied to the cathode and the reactive gas supplied to the anode flow in a same direction; and
that one of the small regions which is located upstream of each of the small regions with respect to flow of the reactive gases is common to both the cathode and the anode.

6. The fuel cell in-plane state estimating system according to claim 13, wherein:
the membrane electrode assembly is equipped with a counter flow channel through which the reactive gas supplied to the cathode and the reactive gas supplied to the anode flow in opposite directions;
that one of the small regions which is adjacently located upstream of each of the small regions with respect to flow of the reactive gas flowing through the cathode is the second small region on the cathode side; and
that one of the small regions which is adjacently located upstream of each of the small regions with respect to flow of the reactive gas flowing through the anode is the second small region on the anode side.

7. A fuel cell in-plane state estimating method comprising:
supplying reactive gases to an anode and a cathode of a membrane electrode assembly of a fuel cell respectively;
deciding power generation environments, wherein said power generation environments include a relative humidity of the reactive gases, a pressure of the cathode and a temperature of the membrane electrode assembly, at inlets of the reactive gases;
virtually dividing the membrane electrode assembly into a plurality of small regions arranged along flow of the reactive gases;
calculating a power generation amount of a first small region as one of the plurality of the small regions on a basis of a power generation environment of a second small region located upstream of the first small region with respect to flow of the reactive gases according to a power generation characteristic defining a relationship between a power generation amount and a power generation environment of the membrane electrode assembly;
calculating consumption amounts of the reactive gases and a production amount of water in the first small region on a basis of the power generation amount of the first small region according to a consumption-production characteristic defining a relationship between consumption amounts of the reactive gases in the membrane electrode assembly and the power generation amount and a relationship between a production amount of water in the membrane electrode assembly and the power generation amount; and
reflecting consumption amounts of the reactive gases and a production amount of water in the second small region on the power generation environment of the second small region to calculate a power generation environment of the first small region.

8. The fuel cell in-plane state estimating method according to claim 7, further comprising:
preparing a membrane electrode assembly piece having a same structure as the membrane electrode assembly and having such a size as can make an in-plane power generation environment substantially homogeneous;
supplying reactive gases to an anode and a cathode of the membrane electrode assembly piece respectively;
measuring a power generation amount of the membrane electrode assembly piece while changing power generation environments at inlets of the reactive gases; and
producing the power generation characteristic on a basis of a result of the measuring of the power generation amount of the membrane electrode assembly piece.

9. The fuel cell in-plane state estimating method according to claim 7, further comprising calculating a resistance value in the first small region on a basis of the power generation environment of the second small region according to a resistance characteristic defining a relationship between a resistance value and a power generation environment of the membrane electrode assembly.

10. The fuel cell in-plane state estimating method according to claim 9, further comprising:
preparing a membrane electrode assembly piece having a same structure as the membrane electrode assembly and having such a size as can make an in-plane power generation environment substantially homogeneous;
supplying reactive gases to an anode and a cathode of the membrane electrode assembly piece respectively;
measuring a resistance value of the membrane electrode assembly piece while changing power generation environments at inlets of the reactive gases; and
producing the resistance characteristic on a basis of a result of the measurement of the resistance value of the membrane electrode assembly piece.

11. The fuel cell in-plane state estimating method according to claim 7, further comprising:
calculating a transfer amount of water in the first small region on a basis of the power generation environment of the second small region according to a water transfer characteristic defining a relationship between a transfer amount of water from the cathode of the membrane electrode assembly to the anode of the membrane electrode assembly and a power generation environment of the membrane electrode assembly;
subtracting a transfer amount of water in the second small region from a sum of an amount of water present in the cathode in the second small region and a production amount of water in the second small region to calculate an amount of water present in the cathode in the first small region when the power generation environment includes an amount of water present in the cathode of the membrane electrode assembly and an amount of water present in the anode of the membrane electrode assembly; and
adding the transfer amount of water in the second small region to an amount of water present in the anode in the second small region to calculate an amount of water present in the anode in the first small region.

12. The fuel cell in-plane state estimating method according to claim 11, further comprising:
preparing a membrane electrode assembly piece having a same structure as the membrane electrode assembly and having such a size as can make an in-plane power generation environment substantially homogeneous;
supplying reactive gases to an anode and a cathode of the membrane electrode assembly piece respectively;
measuring a transfer amount of water in the membrane electrode assembly piece while changing power generation environments at inlets of the reactive gases; and
producing the water transfer characteristic on a basis of a result of the measurement of the transfer amount of water in the membrane electrode assembly piece.

13. A fuel cell in-plane state estimating system comprising:
a membrane electrode assembly of a fuel cell having an anode and a cathode to which reactive gases are supplied respectively to generate power;
an inlet environment detecting device for detecting power generation environments at inlets of the reactive gases, wherein said power generation environments include a relative humidity of the reactive gases, a pressure of the cathode and a temperature of the membrane electrode assembly;
a control device that controls the fuel cell in-plane state estimating system,
wherein:
the control device is equipped with a power generation characteristic storing portion that stores a power generation characteristic defining a relationship between a power generation amount and a power generation environment of the membrane electrode assembly;
a consumption-production characteristic storing portion that stores a consumption-production characteristic defining a relationship between consumption amounts of the reactive gases in the membrane electrode assembly and the power generation amount and a relationship between a production amount of water in the membrane electrode assembly and the power generation amount;
an inlet environment deciding portion that decides the power generation environments at the inlets of the reactive gases according to a result of detection of the inlet environment detecting device;
a small region defining portion that virtually divides the membrane electrode assembly into a plurality of small regions arranged along flow of the reactive gases;
a power generation amount calculating portion that calculates a power generation amount of a first small region as one of the plurality of the small regions on a basis of a power generation environment of a second small region located upstream of the first small region with respect to flow of the reactive gases according to the power generation characteristic;
a consumption-production amount calculating portion that calculates consumption amounts of the reactive gases and a production amount of water in the first small region on a basis of the power generation amount of the first small region according to the consumption-production characteristic; and
a power generation environment updating portion that reflects consumption amounts of the reactive gases and a production amount of water in the second small region on the power generation environment of the second small region to calculate a power generation environment of the first small region.
